(19) United States
(12) Patent Application Publication
(10) Pub. No.: US 2009/0147735 A1
(43) Pub. Date: Jun. 11, 2009

(54) SYSTEM AND METHOD FOR NON-STANDARD WIRELESS BANDWIDTH COMMUNICATIONS

(75) Inventors: Amitava Ghosh, Buffalo Grove, IL (US); Gregory M. Agami, Arlington Heights, IL (US); Chandrasekar Sankaran, Arlington Heights, IL (US); Fan Wang, Chicago, IL (US); Weidong Yang, Schaumburg, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/950,435

(22) Filed: Dec. 5, 2007

(51) Int. Cl. H04Q 7/00

(52) U.S. Cl. 370/329

(57) ABSTRACT

A wireless communications method and device including a transmitter (130) configured to transmit according to an Orthogonal Frequency Division Multiplexing transmission standard (300), such as the WiMAX standard. The wireless communications device (120) includes a transmission bandwidth controller (136) adapted to configure the transmitter (130) to adjust a transmitted bandwidth (312) by at least one of 1) configuring at least one of a first set of punctured subcarriers (324) and a second set of punctured subcarriers (326) to not be used for data transmission. The first set of punctured subcarriers and the second set of punctured subcarriers are located within opposite edges of the transmission bandwidth (340); and 2) configuring at least a first set of guardband subcarriers (322) and a second set of guardband subcarriers (330), which are located on opposite edges of the transmission bandwidth, to be used for data transmission.

### CROSS-REFERENCE TO RELATED APPLICATION

Not Applicable

### FIELD OF THE INVENTION

The present invention generally relates to radio frequency signal modulation, and more particularly relates to radio frequency modulation techniques that support adjustment of transmitted spectral bandwidth.

### BACKGROUND OF THE INVENTION

Commercially available wireless communications systems, such as cellular telephone and commercially available data communications systems, e.g., Wi-Fi and WiMAX, often utilize over-the-air interfaces that are defined by one or more standards. Over-the-air interfaces such as WiMAX define RF signal modulation formats that are able to use one of several pre-defined fixed spectral bandwidths. For example, some wireless communications standards specify Orthogonal Frequency Division Multiplexing (OFDM), which uses a number of subcarriers across the transmitted spectral bandwidth, to modulate data on a transmitted signal. Wireless communications standards that specify OFDM modulation include WiMAX “Ultra Mobile Broadband” (UMB), and 3GPP Long Term Evolution (LTE) wireless communications standards. The WiMAX standard, i.e., the IEEE 802.16e standard with WiMAX mobile profile, specifies several transmitted signal RF bandwidths that include, for example, 5 MHz and 7 MHz transmission bandwidths. Many wireless communications devices are readily available that conform to these data transmission standards.

Some wireless communications operations may have spectrum which uses non-standard bandwidth allocations suitable for their legacy systems which may be proprietary. For example, an operator may have an RF frequency spectrum allocation that uses 6 MHz of allocation for their legacy systems. Using commercially available devices that conform to transmission standard that don't include a transmission format that uses 6 MHz requires that those devices be configured to use less bandwidth that is available. For example, a WiMAX device can operate at either 5 MHz or 7 MHz but not at any defined bandwidths in-between. An operator with a 6 MHz spectrum allocation would be required to select the 5 MHz WiMAX transmission bandwidth option since the 7 MHz transmission bandwidth of the standard is too large. Using a transmission bandwidth of 5 MHz when the operator has a 6 MHz allocation wastes 1 MHz of that allocation.

### SUMMARY OF THE INVENTION

Briefly, in accordance with one aspect of the present invention, a wireless communications system includes a base station that is adapted to communicate by using a modified WiMAX transmission standard. The WiMAX transmission standard is modified to support non-standard transmission bandwidths. The wireless communications system also includes a remote transceiver that is in wireless communications with the base station, the remote transceiver is adapted to communication by a WiMAX communications standard and the modified WiMAX transmission standard. The remote transceiver includes a transmitter configured to transmit according to the WiMAX transmission standard. The remote transceiver further includes a transmission bandwidth controller adapted to configure the transmitter to adjust the transmitted bandwidth of a transmission. Adjusting the transmitted bandwidth of the transmission is performed by one of 1) configuring at least one of a first set of punctured subcarriers and/or a second set of punctured subcarriers to not be used for data transmission, wherein the first set of punctured subcarriers and the second set of punctured subcarriers are located within opposite edges of a transmission bandwidth of the WiMAX transmission standard; and 2) configuring at least a first set of guardband subcarriers and/or a second set of guardband subcarriers to be used for data transmission. The first set of guardband subcarriers and the second set of guardband subcarriers are located within opposite edges of a transmission bandwidth of the WiMAX transmission standard

In accordance with another aspect of the present invention, a method for wirelessly communicating data includes configuring a transmitter to adjust a transmitted bandwidth of the transmitter. The configuring includes at least one of 1) configuring at least one of a first set of punctured subcarriers and/or a second set of punctured subcarriers to not be used for data transmission. The first set of punctured subcarriers and the second set of punctured subcarriers are located within opposite edges of the transmission bandwidth; and 2) configuring at least a first set of guardband subcarriers and/or a second set of guardband subcarriers to be used for data transmission. The transmitter is adapted to transmit according to an Orthogonal Frequency Division Multiplexing transmission standard, the Orthogonal Frequency Division Multiplexing transmission standard defining a transmission spectrum comprising a transmission bandwidth comprising a plurality of transmitted subcarriers, a first guardband comprising a first plurality of guardband subcarriers, and/or a second guardband comprising a second plurality of guardband subcarriers, the first guardband being located adjacent to a first edge of the transmission bandwidth and the second guardband being located adjacent to a second edge of the transmission bandwidth, the first edge being opposite the second edge.

### BRIEF DESCRIPTION OF THE DRAWINGS

The accompanying figures where like reference numerals refer to identical or functionally similar elements throughout the separate views and which together with the detailed description below are incorporated in and form part of the specification, serve to further illustrate various embodiments to explain various principles and advantages all in accordance with the present invention.

FIG. 1 illustrates a communicating base station and remote wireless transceiver pair, in accordance with one embodiment of the present invention.

FIG. 2 illustrates a transmitted signal spectrum definition, in accordance with one embodiment of the present invention.

FIG. 3 illustrates a sub-carrier tone spectrum allocation used for wireless communications between a transmitter and receiver of a communicating base station and mobile wireless transceiver pair, in accordance with one embodiment of the present invention.

FIG. 4 illustrates a sub-carrier tone allocation determination process, in accordance with one embodiment of the present invention.

### DETAILED DESCRIPTION

As required, detailed embodiments of the present invention are disclosed herein; however, it is to be understood that the disclosed embodiments are merely examples of the invention, which can be embodied in various forms. Therefore, specific structural and functional details disclosed herein are not to be interpreted as limiting, but merely as illustrative examples for the claims and as a representative basis for teaching one skilled in the art to variously employ the present invention in virtually any appropriately detailed structure. Further, the terms and phrases used herein are not intended to be limiting; but rather, to provide an understandable description of embodiments of the invention.

The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically.

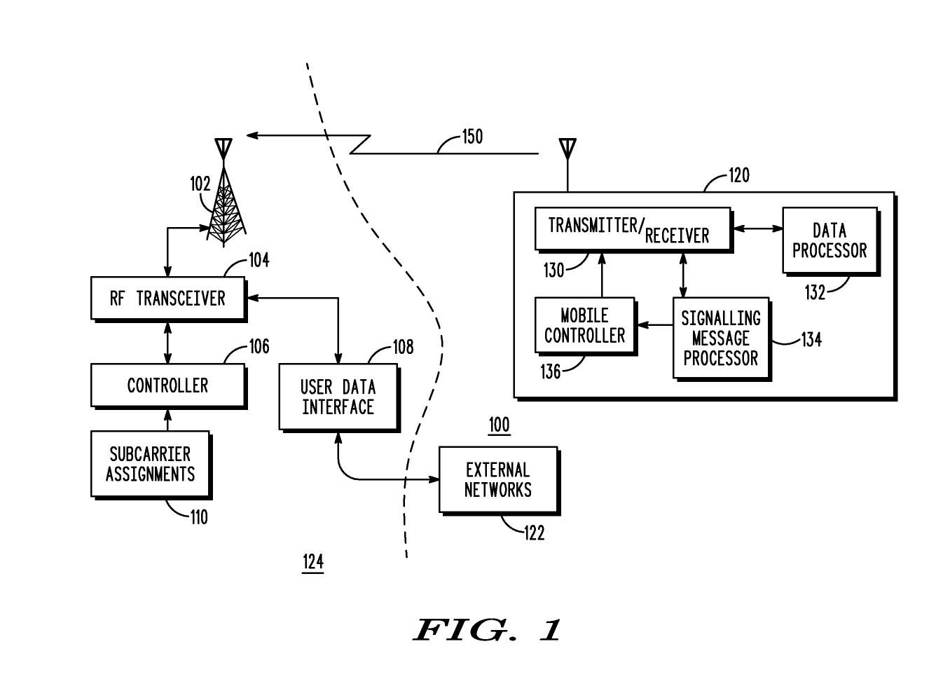

FIG. 1 illustrates a communicating base station and remote wireless transceiver pair 100, in accordance with one embodiment of the present invention. The communicating base station and remote wireless transceiver pair 100 illustrates a remote wireless transceiver 120 that wirelessly communicates with a base station 124 through a wireless link 150.

In one embodiment, the remote wireless transceiver 120 exchanges data with the base station 124 through the use of a WiMAX communications standard that is modified as described below to perform efficient utilization of RF transmission bandwidths that are not equal to those defined by the WiMAX standard. The communicating base station and remote wireless transceiver pair 100 shows only one base station antenna 102 and one remote wireless transceiver 120 to simplify this illustration and facilitate the description of the relevant aspects of one embodiment of the present invention. It is clear that practical systems incorporating embodiments of the present invention are able to include many mobile wireless transceivers 120 that are able to communicate with multiple base stations 124, including operations to hand off mobile wireless transceivers 120 between base stations 124. It is further clear that although a mobile wireless transceiver 120 is illustrated and discussed herein, a fixed wireless transceiver is also able to operate in a similar manner with the base station 124 of this example.

The mobile wireless transceiver 120 of one embodiment of the present invention includes a transmitter/receiver component 130. The transmitter/receiver component 130, or transceiver, is used to generate RF signals that are modulated with user data for transmission and to also process received RF signals to extract transmitted data from the received signal. User data is exchanged between the transmitter/receiver component 130 and a data processor 132. Data processor 132 of one embodiment accepts received data and outputs data that originates from the mobile wireless transceiver 120, or from devices in communications with the mobile wireless transceiver 120.

The mobile wireless transceiver 120 includes a signaling message processor 134 and a mobile controller 136. The signaling message processor 134 receives signaling messages from the base station 124 that contain information needed to properly configure the mobile wireless transceiver 120 for operation with the base station 124. As is described below, the signaling message processor 134 receives and processes messages and indicators to determine if non-standard RF transmission bandwidths are to be used for wireless communications with a particular base station 124. The signaling message processor 134 of one embodiment processes signaling messages used to, for example, co-ordinate conventional WiMAX communications.

The mobile controller 136 performs processing required to control the mobile wireless transceiver 120, including processing to properly configure the transmitter/receiver component 130 to properly operate as part of a wireless network. The mobile controller 136 of one embodiment receives configuration indicators, such as values of reserved bits in signaling messages and other dedicated signaling messages, from the base station 124 and configures the mobile wireless transceiver 120 as required for proper operation, including adjustment of transmission bandwidths as is described below.

The base station 124 includes a base station antenna 102 that is connected to an RF transceiver 104. In one embodiment, the RF transceiver 104 supports wireless communications according to the WiMAX standard but allowing the use of transmission bandwidths that are not equal to transmission bandwidths defined by the WiMAX standard. Further embodiments of the present invention include RF transceivers, or one of a transmitter or receiver in embodiments that support one-way wireless communications, that support wireless communications according to any suitable standard. In one embodiment, the RF transceiver 104 is adapted to alter its configuration as described below in order to support complete utilization of non-standard RF spectral bandwidth allocations.

The RF transceiver 104 of one embodiment exchanges data with a user data interface 108. User data interface 108 provides a data interface between external networks 122, such as the Internet or other public and/or private networks, and mobile wireless transceivers 120. Data to be transmitted to or received from mobile wireless transceivers 120 is exchanged through the RF transceiver 104. The RF transceiver, in turn, transmits and/or receives data through the over-the-air interface 150 with one or more mobile wireless transceivers 120.

A controller 106 controls the operation of the RF transceiver 104 in order to efficiently communicate data through the over-the-air interface 150 by using non-standard RF spectral bandwidths under which the RF transceiver 104 is otherwise operating. One embodiment of the present invention is able to have one or more controllers that are able to each control multiple RF transceivers that are located either at one transceiver location or at multiple transceiver locations. In one embodiment, a transceiver location is defined as a location that is associated with a single base station tower 102. The controller 106 is further able to transmit commands to the mobile wireless transceiver 120 to indicate that non-standard transmission spectral bandwidths are to be used for wireless communications with the base station 124.

The controller 106 of one embodiment includes a scheduler component that is able to transmit signaling messages to the mobile wireless transceiver 120 that control the operation of the mobile wireless transceiver 120. One such signaling message is transmitted using the broadcast channel such as a BCH, FCH, MAP or DCD (Downlink Channel Descriptor) message as are used by one embodiment of the present invention. The use of a BCH, FCH/MAP or DCD message to cause the adjustment of transmitted bandwidths for a mobile wireless transceiver 120 is described below.

One embodiment of the present invention allows an RF transceiver designed to work with one or more wireless communications standards to communicate via RF transmissions that utilize RF spectral bandwidths that are different than those defined by the wireless communications standards implemented by that RF transceiver. In one example, RF transceivers, both those included in base stations and in mobile or mobile user devices, that are designed to operate with WiMAX networks are able to be configured to efficiently utilize RF spectral bandwidths that are different than those defined by the WiMAX standards. The use of WiMAX compliant mobile wireless transceivers 120 allows users to use the same mobile wireless transceiver 120 to communicate with the non-standard base station 124 and to also communicate with the large number of standards compliant base stations that conform to the WiMAX standard. One embodiment of the present invention defines subcarrier assignments 110 for each transceiver location while further embodiments include a database of subcarrier assignments for multiple transceiver locations. That database of subcarrier assignments is accessed by controllers connected to each of those RF transceivers. In one embodiment, the subcarrier assignments 110 are a user channel bandwidth allocation specification.

The RF transmission standards used by one embodiment of the present invention utilize RF modulation techniques, such as OFDM, that assign a number of subcarriers across the spectral bandwidth allocated to each mode of transmission defined by the standard. For example, the WiMAX standard defines several bandwidth options, including configurations that transmit signals with bandwidths of 3.5 MHz, 5 MHz, 7 MHz, 10 MHz, 15 MHz, and 20 MHz.

One embodiment of the present invention allows a transmitter and receiver that are designed to operate according to these standards to adjust the spectral bandwidth of transmitted signals to fully utilize bandwidth allocations that are different than those defined by the particular standard. In one embodiment, a reserved bit in a BCH/FCH/MAP/DCD message is used to indicate to mobile wireless transceivers 120 that a non-standard bandwidth is being utilized. This reserved bit allows the mobile wireless transmitter 120 to adjust its configuration to properly conform to the adjusted transmission bandwidths.

In one embodiment, the base station 124 is adapted to communicate by using a modified WiMAX transmission standard. The WiMAX transmission standard is modified in this case to support non-standard transmission bandwidths. The remote wireless transceiver 120, which is in wireless communications with the base station 124, is adapted to communicate with both a WiMAX communications standard based transmission and the modified WiMAX transmission in order to achieve the operation described below.

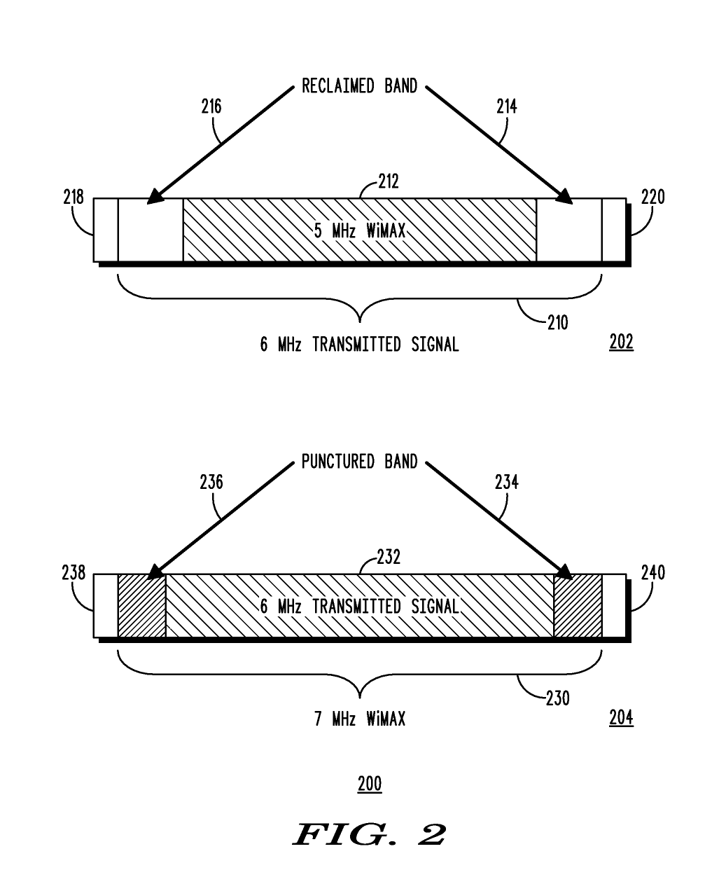

FIG. 2 illustrates a transmitted signal spectrum definition 200, in accordance with one embodiment of the present invention. The transmitted signal spectrum definition 200 illustrates two transmission modes that one embodiment of the present invention is able to utilize to optimize the transmitted bandwidth of a communications signal for a channel bandwidth that is not defined by a standard under which equipment used to communicate data is otherwise operating under. A first mode 202 illustrates reclaiming spectral bandwidth from the guardbands defined by the standard. A second mode 204 illustrates “puncturing” the transmitted bandwidth defined by the standard by defining some subcarriers in the edge of the usually transmitted bandwidth as not to be used for transmission, thereby reducing the transmitted bandwidth of the signal.

The first mode 202 illustrates what is generally referred to as a 5 MHz WiMAX defined transmission spectrum 212 where a portion of the guardbands are defined as a first reclaimed band 214 and a second reclaimed band 216. As defined by the WiMAX standard, a 5 MHz WiMAX defined transmission utilizes 421 subcarriers with a utilized bandwidth of approximately 4.59 MHz. In this example, the first reclaimed band 214 and the second reclaimed band 216 are each approximately 0.5 MHz wide. In one embodiment, the first reclaimed band 214 and the second reclaimed band 216 each contain 42 subcarriers, leading to a reclaimed bandwidth of approximately 495 KHz. Adding the first reclaimed band 214 and the second reclaimed band 216 to the 5 MHz WiMAX defined transmit spectrum 212 produces an approximately 6 MHz transmitted signal 210. The portion of the WiMAX defined guardband that does not include the first reclaimed band 214 and a second reclaimed band 216, i.e., the first remaining sideband 218 and the second remaining sideband 220, do not contain transmitted subcarriers. One embodiment of the present invention signals to mobile wireless transceivers 120 that guardband subcarriers are to be used for data communications by using a reserved bit in the BCH/FCH/MAP/DCD to indicate whether non-standard bandwidths are to be used for data communications. Further embodiments utilize a specially defined signaling message that indicates the number of guardband subcarriers that are to be used for data communications by the mobile wireless transceiver 120.

The second mode 204 illustrates what is generally referred to as a 7 MHz WiMAX defined transmit spectrum 230, with a portion that is “punctured” such that the subcarriers within the “punctured bands” are not transmitted. A first punctured band 234 and a second punctured band 236 are shown at the edge of the 7 MHz WiMAX defined transmit spectrum 230. In this example, the first punctured band 234 and a second punctured band 236 are each approximately 0.5 MHz wide. In one embodiment, the first punctured band 234 and the second punctured band 236 each contain 70 subcarriers, leading to a punctured bandwidth of approximately 547 KHz. Reducing the 7 MHz WiMAX defined transmit spectrum 230 by the approximately 0.5 MHz bandwidth of each of the first punctured band 234 and a second punctured band 236 produces a 6 MHz transmitted signal 232. The punctured bands are adjacent to the first WiMAX defined guardband 238 and the second WiMAX defined guardband 240. One embodiment of the present invention signals to mobile transceivers 120 to puncture the standards defined transmit spectrum by not using subcarriers at the edge of that spectrum through the use of a reserved bit in the BCH/FCH/MAP/DCD to indicate that whether non-standard bandwidths are to be used for data communications. WiMAX defines two sub-channelization methods, namely PUSC and Band-AMC, that are respectively used for frequency diverse and frequency selective scheduling. If the scheduler is configured in the Band AMC mode, 4 bands corresponding to 144 sub-carriers are reserved and the reserved bands are put in the unused region. If the scheduler is configured in the PUSC mode, the band edge sub-carriers are punctured thus effectively increasing the coding rate.

In the communicating base station and remote wireless transceiver pair 100 of one embodiment, the base station 124 and the mobile wireless transceiver 120 include a transmitter configured to transmit according to an Orthogonal Frequency Division Multiplexing transmission standard that defines a transmitted signal spectrum that is similar to the transmitted signal spectrum definition 200. The transmission standard defines a transmission spectrum that includes a transmission bandwidth with a plurality of transmitted subcarriers, a first guardband comprising a first plurality of guardband subcarriers, and a second guardband comprising a second plurality of guardband subcarriers. The first guardband is located adjacent to a first edge of the transmission bandwidth and the second guardband is located adjacent to a second edge of the transmission bandwidth, the first edge being opposite to the second edge.

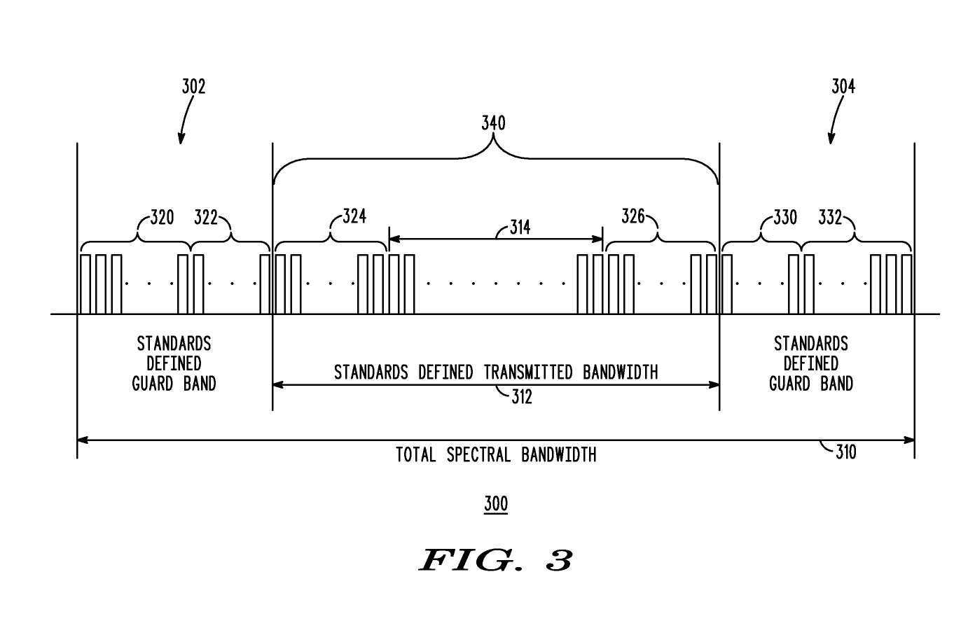

FIG. 3 illustrates a sub-carrier tone spectrum allocation 300 used for wireless communications between a transmitter and receiver of a communicating base station and mobile wireless transceiver pair 100, in accordance with one embodiment of the present invention. Similar sub-carrier tone spectrum allocation 300 are used by transmitters in both the base station 124 and the mobile wireless transceiver 120 in order to communicate by efficiently utilizing RF spectral bandwidths that are different than those defined by the standard under which the RF transceiver 104, or the mobile wireless transceiver 120, are designed to otherwise operate.

The illustrated sub-carrier tone spectrum allocation 300 illustrates a number of subcarriers that are defined across a total spectral bandwidth 310. The wireless communications standard of one embodiment of the present invention includes a standards defined transmission bandwidth 312 in which are allocated a number of standards defined transmitted subcarriers 340. In addition to the standards defined transmitted subcarriers 340, the wireless communications standard of one embodiment further defines standard defined guardbands, including a first standards defined guardband 302 and a second standard defined guardband 304. The first standards defined guardband is located adjacent to a first edge of the transmission bandwidth 312 and the second guardband being located adjacent to a second edge of the transmission bandwidth 312, with the first edge being opposite the second edge. Each of the standards defined guardbands includes a number of subcarriers that span the defined guardband. When operating according to the wireless communications standard, a transmitter will not transmit subcarriers within either of the two standards defined guardbands.

One mode of operation of one embodiment of the present invention is to configure a transmitter to transmit a signal that has a wider bandwidth than is defined by the standard under which the transmitter is designed to operate. In this mode of operation, the transmitter is configured to potentially utilize all subcarriers within the standards defined subcarriers 340 as well as subcarriers in the standards defined guardbands that are adjacent to the standards defined transmitted bandwidth 312. One example of this mode of operation is a case where a transmitter is desired to use a 6 MHz bandwidth with the transmitted signal occupying 90-92% of the total allocated spectrum (6 MHz in this case) by configuring the transmitter to operate as defined by the WiMAX standard for a transmission bandwidth of 5 MHz with the transmitted signal occupying 90-92% of the total allocated spectrum (5 MHz in this case). In addition to the transmitting the standards defined subcarriers 340, the transmitter is defined to transmit additional subcarriers that occupy an additional approximately 0.5 MHz, as described above, in the portion of each of the standards defined guardbands that is adjacent to the standards defined transmitted bandwidth. In the illustrated example, a first guardband subcarrier set 322 and a second guardband subcarrier set 330 are used by the transmitter to convey data.

The transmitters that are configured to potentially transmit all of the subcarriers within the standards defined transmitted bandwidth 312 and additional subcarriers that occupy approximately 0.5 MHz, as described above, in each of the standards defined guardbands transmit a signal that occupies 90-92% of 6 MHz allocation for this scenario. The receivers in this scenario are also configured to process the additional subcarriers within the standards defined guardbands in addition to the standards defined subcarriers 340. Such operation fully utilizes the 6 MHz frequency allocation to transmit data by using standards compliant transceivers that conform to standards that do not include a 6 MHz transmission bandwidth configuration.

The data transmitted by a transmitter in both embodiments of the present invention includes error correction encoding for all of the transmitted data. In one example, turbo codes as defined by the standards are used to encode blocks of data that are then distributed across the transmitted subcarriers. In the above described scenario where additional subcarriers are used to transmit data over a wider bandwidth, one embodiment of the present invention utilizes the same error correction format as defined by the standards.

One specific example of configuring the RF transceivers of a commercial device that operates under the WiMAX standard and adapting the configuration of the device to utilize the 5 MHz WiMAX RF modulation format is as follows. The 5 MHz configuration for the 5 MHz transmission of WiMAX defines 91 guard subcarriers. One embodiment operates to re-claim 84 subcarriers (i.e., 3 subchannels) that are within the standards defined guardbands for data transmission. In this configuration, channel usage is about 92% ((420 standards defined subcarriers+84 additional subcarriers)*(10.94(KHz/subcarrier))/6000 (KHz/6 MHz channel)=92%). This channel usage is similar to the channel usage for a conventional WiMAX system when operating in the conventional configuration for a 5 MHz channel.

One embodiment of the present invention is for the system to be able to operate in a hybrid mode, where a standard wireless mobile transceiver for example configured for 5 MHz WiMAX operations, can still operate in a 6 MHz RF bandwidth system. Such a wireless mobile transceiver that is able to operate in a 6 MHz system can take advantage of the additional bandwidth (which in turn increases the throughput) and can also operate in a conventional WiMAX system utilizing a 5 MHz channel.

One embodiment of the present invention uses the guardband subcarriers of the 5 MHz WiMAX standard definition in addition to data sub-carriers for multicast/broadcast. Such a system, similar to those described above, re-claims 3 subchannels for use in multicast/broadcast. The multicast/broadcast is able to operate within one sector and/or broadcast across different sectors. Such an embodiment is further able to support a hybrid mode, where a standard WiMAX transceiver, e.g., configured for 5 MHz WiMAX operations, can still operate in 6 a MHz RF bandwidth system. Such a wireless mobile transceiver that is able to operate in a 6 MHz system can take advantage of the additional bandwidth (which in turn increases the edge data rate for multicast/broadcast) and can also operate in a conventional WiMAX system utilizing a 5 MHz channel.

An alternative mode of operation of one embodiment of the present invention is to configure a transmitter to transmit a signal that has a narrower bandwidth than is defined by the standard under which the transmitter is designed to operate. In this mode of operation, the transmitter is configured to not utilize subcarriers that are within the standards defined subcarriers 340. One example of this mode of operation is a case where a transmitter is desired to use a 6 MHz bandwidth by configuring the transmitter to otherwise operate as defined by the WiMAX standard for a transmission bandwidth of 7 MHz. In this mode of operation, the transmitter is defined to transmit a reduced set of standards defined subcarriers 314 and to not transmit a first set of edge subcarriers 324 and a second set of edge subcarriers 326 that are within the standards defined transmitted bandwidth 312. The first set of edge subcarriers 324 and the second set of edge subcarriers 326 each occupy the outer approximately 0.5 MHz, as is described above, at the edges of the standards defined transmitted bandwidth 312. In this particular example, the standards defined transmitted bandwidth 312 is 7 MHz and the first set of edge subcarriers 324 and the second set of edge subcarriers 326 each occupy approximately 0.5 MHz, as is described above, of that bandwidth. By configuring the transmitter to not transmit the first set of edge subcarriers 324 and the second set of edge subcarriers 326, the transmitter transmits an RF signal that only uses 6 MHz of spectral bandwidth.

WiMAX defines two sub-channelization methods, namely PUSC and Band-AMC, that are respectively used for frequency diverse and frequency selective scheduling. A scheduler of one embodiment of the present invention is configured in the Band-AMC mode and reserves 4 bands corresponding to 144 sub-carriers that are put in the unused region. The channel utilization for this configuration is therefore (865 subcarriers−144 subcarriers)*(7.8125 KHz/subcarrier)=93.88% of 6 MHz. This compares with 96.54% utilization of conventional WiMAX channel utilization for 7 MHz AMC operations and with 94.74% channel utilization in 5 MHz WiMAX AMC.

A scheduler of one embodiment of the present invention is configured in the PUSC mode and reserves 5 sub-channels corresponding to 140 sub-carriers. These band edge sub-carriers are then punctured, i.e., not used for transmission, which effectively increases the error correction coding rate by 0.17 (140/840). The channel utilization in this scenario is (840−140 (sub-carriers))*7.8125=91.15% of 6 MHz.

Further embodiments of the present invention are able to also configure the receiver to reflect that the first set of edge subcarriers 324 and the second set of edge subcarriers 326 are not transmitted, and therefore only process the reduced set of standards defined subcarriers 314.

As an example of one embodiment of the present invention, the transmitted spectral bandwidth is adjusted by configuring transmitters to transmit either more subcarriers than are specified within the standards defined subcarriers 340 or to not transmit some of the subcarriers that are specified within the standards defined subcarriers 340. In another embodiment, a transmission bandwidth controller, such as controller 106 or mobile controller 136, configures the transmitter to adjust a transmitted bandwidth by at least one of: a) configuring at least one of a first set of punctured subcarriers 324 and a second set of punctured subcarriers 326 to not be used for data transmission. The first set of punctured subcarriers 324 and the second set of punctured subcarriers 326 are located within opposite edges of the transmission bandwidth 340; and b) configuring at least a first set of guardband subcarriers 322 and a second set of guardband subcarriers 330 to be used for data transmission.

By configuring transmitters to transmit a different number of subcarriers, it is possible to adjust the bandwidth of the transmitted RF signal. In conjunction with configuring the transmitters to transmit more or fewer subcarriers, the receivers in some operational scenarios that are receiving the transmitted signals are also able to be configured to properly receive the transmitted signals.

In one embodiment of the present invention wherein the transmission bandwidth controller adjusts the transmitted bandwidth by configuring at least one of the first set of punctured subcarriers and the second set of punctured subcarriers to not be used for data transmission, the first set of punctured subcarriers and the second set of punctured subcarriers are specified by a wireless transmission system scheduler, that is part of controller 106, that transmits an uplink grant that excludes the first set of punctured subcarriers and the second set of punctured subcarriers from the transmission bandwidth.

In one embodiment of the present invention where the transmission bandwidth controller adjusts the transmitted bandwidth by configuring at least one of the first set of punctured subcarriers and the second set of punctured subcarriers to not be used for data transmission, the transmission standard defines an error correction encoding scheme to be applied to data communicated through the plurality of transmitted subcarriers. In one embodiment the transmitter performs error correction encoding according to the error correction encoding scheme to produce a plurality of error correction encoded channel bits and discards error correction encoded channel bits defined by the transmission standard to be modulated on the at least one of the first set of punctured subcarriers and the second set of punctured subcarriers.

In one embodiment of the present invention, where the transmission bandwidth controller adjusts the transmitted bandwidth by configuring the at least the first set of guardband subcarriers and the second set of guardband subcarriers to be used for data transmission, the wireless communications device further includes a receiver adapted to receive, in response to a command from a controller, the at least one of the first set of guardband subcarriers and the second set of guardband subcarriers that are received by the receiver.

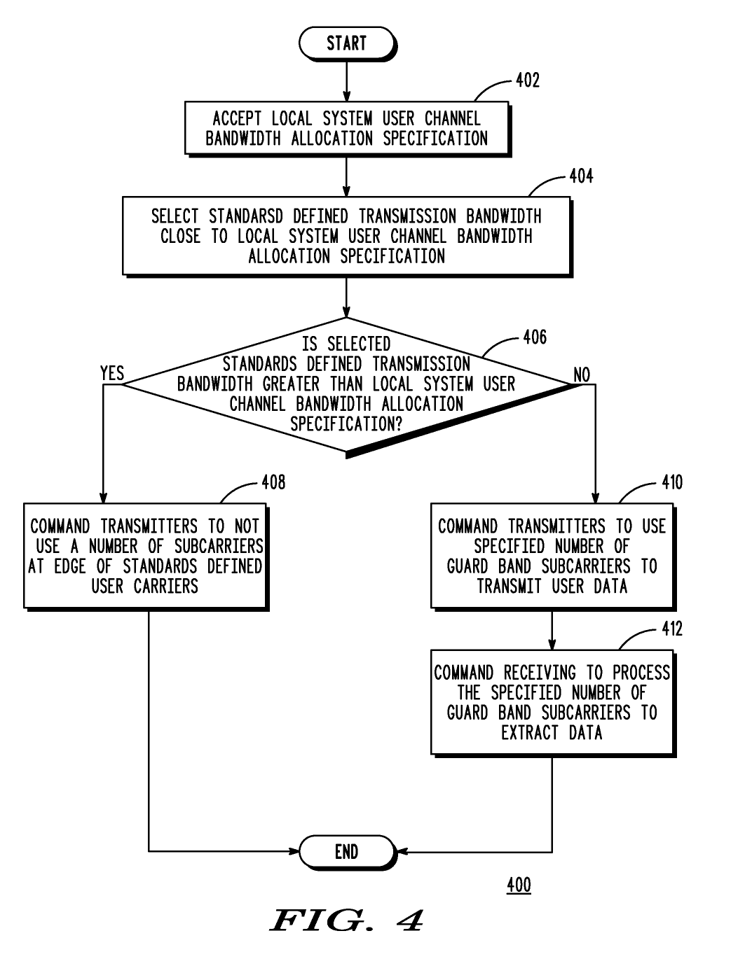

FIG. 4 illustrates a sub-carrier tone allocation determination process 400, in accordance with one embodiment of the present invention. The sub-carrier tone allocation determination process 400 begins by accepting, at step 402, a local system user channel bandwidth allocation specification. In one embodiment, the local system user channel bandwidth specification is able to be a specification that devices are able to use a 6 MHz wide RF channel for wireless data communications. Any suitable specification of local system user channel bandwidth specifications are able to be accepted by one embodiment of the present invention, including pre-defined bandwidth specifications that are programmed in to base station equipment.

The sub-carrier tone allocation determination process 400 continues by selecting, at step 404, a standards defined transmission bandwidth close to the local system user channel bandwidth allocation specification. In one embodiment, the standards defined transmission bandwidth includes one or both of the WiMAX 5 MHZ and WiMAX 7 MHz transmit channel definition. In such a case, either of these standards defined transmission bandwidths is able to be chosen. In one embodiment, a system configurable preference is able to be defined to select one of these standards defined transmission preferences based upon, for example, compatibility with mobile wireless transceivers that may be configured to more efficiently utilize one selection. Further embodiments of the present invention are able to have the standards defined transmission bandwidth preconfigured by programming of base station equipment.

The sub-carrier tone allocation determination process 400 continues by determining, at step 406, if the standards defined transmission bandwidth is greater than the local system user channel bandwidth allocation specification. If it is, the processing continues by commanding, at step 408, the transmitters in the system to not use a number of subcarriers at the edge of the standards defined user carriers. In one embodiment, mobile wireless transceivers are able to be commanded to not use the number of subcarriers by using the scheduler to command a reduction in the spectral bandwidth of the transmitted signal.

If the standards defined transmission bandwidth is not greater than the local system user channel bandwidth allocation specification, the processing continues by commanding, at step 410, the transmitters in the system to use a specified number of guardband subcarriers to transmit user data. The processing then commands, at step 412, receivers to process the specified number of guardband subcarriers to extract transmitted data. The mobile transceivers are able to be commanded to use a number of guardband subcarriers through signaling encoded into a reserved bit in the FCH/MAP/DCD. The processing then ends.

The present invention may also be embedded in a computer program product, which comprises all the features enabling the implementation of the methods described herein, and which—when loaded in a computer system—is able to carry out these methods. Computer program means or computer program in the present context mean any expression, in any language, code or notation, of a set of instructions intended to cause a system having an information processing capability to perform a particular function either directly or after either or both of the following a) conversion to another language, code or, notation; and b) reproduction in a different material form.

Each computer system may include, inter alia, one or more computers and at least one computer readable medium that allows the computer to read data, instructions, messages or message packets, and other computer readable information. The computer readable medium may include non-volatile memory, such as ROM, Flash memory, Disk drive memory, CD-ROM, SIM card, and other permanent storage. Additionally, a computer medium may include, for example, volatile storage such as RAM, buffers, cache memory, and network circuits.

The terms program, software application, and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system.

Reference throughout the specification to “one embodiment” means that a particular feature, structure, or characteristic described in connection with the embodiment is included in at least one embodiment of the present invention. Thus, the appearances of the phrases “in one embodiment” in various places throughout the specification are not necessarily all referring to the same embodiment. Furthermore, the particular features, structures, or characteristics may be combined in any suitable manner in one or more embodiments. Moreover these embodiments are only examples of the many advantageous uses of the innovative teachings herein. In general, statements made in the specification of the present application do not necessarily limit any of the various claimed inventions. Moreover, some statements may apply to some inventive features but not to others. In general, unless otherwise indicated, singular elements may be in the plural and visa versa with no loss of generality.

While the various embodiments of the invention have been illustrated and described, it will be clear that the invention is not so limited. Numerous modifications, changes, variations, substitutions and equivalents will occur to those skilled in the art without departing from the spirit and scope of the present invention as defined by the appended claims.

What is claimed is:

1. A wireless communications device, comprising:
a transmitter configured to transmit according to an Orthogonal Frequency Division Multiplexing transmission standard, the Orthogonal Frequency Division Multiplexing transmission standard defining a transmission spectrum comprising a transmission bandwidth comprising a plurality of transmitted subcarriers, a first guardband comprising a first plurality of guardband subcarriers, and a second guardband comprising a second plurality of guardband subcarriers, the first guardband being located adjacent to a first edge of the transmission bandwidth and the second guardband being located adjacent to a second edge of the transmission bandwidth, the first edge being opposite the second edge;
a transmission bandwidth controller adapted to configure the transmitter to adjust a transmitted bandwidth of a signal complying with the Orthogonal Frequency Division Multiplexing transmission standard that is transmitted by the transmitter by at least one of:
configuring at least one of a first set of punctured subcarriers and a second set of punctured subcarriers to not be used for data transmission, wherein the first set of punctured subcarriers and the second set of punctured subcarriers are located within opposite edges of the transmission bandwidth, and
configuring at least a first set of guardband subcarriers and a second set of guardband subcarriers to be used for data transmission.

2. The wireless communications device of claim 1, wherein the transmission bandwidth controller adjusts the transmitted bandwidth of the signal complying with the Orthogonal Frequency Division Multiplexing transmission standard by configuring the at least one of the first set of punctured subcarriers and the second set of punctured subcarriers to not be used for data transmission, wherein the at least one of the first set of punctured subcarriers and the second set of punctured subcarriers are specified by a wireless transmission system scheduler that transmits an uplink grant message that excludes the first set of punctured subcarriers and the second set of punctured subcarriers from the transmission bandwidth.

3. The wireless communications device of claim 1, wherein the transmission bandwidth controller configures the transmitter in response to receiving an indication transmitted in a reserve bit of a signaling message transmitted from a base station.

4. The communications device of claim 1, wherein the transmission bandwidth controller adjusts the transmitted bandwidth by configuring the at least one of the first set of punctured subcarriers and the second set of punctured subcarriers to not be used for data transmission.

5. The wireless communications device of claim 1, wherein the transmitter is adapted to communicate with a base station according to the Orthogonal Frequency Division Multiplexing transmission standard.

6. The wireless communications device of claim 1, wherein the transmission bandwidth controller adjusts the transmitted bandwidth by configuring the at least one of the first set of guardband subcarriers and the second set of guardband subcarriers to be used for data transmission, the wireless communications device further comprising a receiver adapted to receive, in response to a command from a controller, the at least one of the first set of guardband subcarriers and the second set of guardband subcarriers that are received by the receiver.

7. The wireless communications device of claim 6, wherein the transmitter and the receiver are adapted to communicate with a base station according to a standardized protocol.

8. A method for wirelessly communicating data, the method comprising:
configuring a transmitter to adjust a transmitted bandwidth of the transmitter, the configuring comprising at least one of
configuring at least one of a first set of punctured subcarriers and a second set of punctured subcarriers to not be used for data transmission, wherein the first set of punctured subcarriers and the second set of punctured subcarriers are located within opposite edges of the transmission bandwidth, and
configuring at least one of a first set of guardband subcarriers and a second set of guardband subcarriers to be used for data transmission,
wherein the transmitter is adapted to transmit according to an Orthogonal Frequency Division Multiplexing transmission standard, the Orthogonal Frequency Division Multiplexing transmission standard defining a transmission spectrum comprising a transmission bandwidth comprising a plurality of transmitted subcarriers, a first guardband comprising a first plurality of guardband subcarriers, and a second guardband comprising a second plurality of guardband subcarriers, the first guardband being located adjacent to a first edge of the transmission bandwidth and the second guardband being located adjacent to a second edge of the transmission bandwidth, the first edge being opposite the second edge.

9. The method of claim 8, wherein the configuring comprises:
adjusting the transmitted bandwidth by configuring the at least one of the first set of punctured subcarriers and the second set of punctured subcarriers to not be used for data transmission, wherein the at least one of the first set of punctured subcarriers and the second set of punctured subcarriers are specified by a wireless transmission system scheduler that transmits a reserved bit in a message transmitted via a broadcast channel, the reserved bit indicating to exclude the first set of punctured subcarriers and the second set of punctured subcarriers from the transmission bandwidth.

10. The method of claim 8, wherein the configuring of the transmitter is performed in response to receiving an indication transmitted in a reserve bit in a message transmitted via a broadcast channel transmitted from a base station.

11. The method of claim 8, wherein the adjusting of the transmitted bandwidth comprises configuring the at least one of the first set of punctured subcarriers and the second set of punctured subcarriers to not be used for data transmission.

12. The method of claim 8, wherein the adjusting comprises configuring the at least one of the first set of guardband subcarriers and the second set of guardband subcarriers to be used for data transmission, the method further comprising receiving and processing, in response to a command from a controller, the at least one of the first set of guardband subcarriers and the second set of guardband subcarriers that are received by the receiver.

13. The wireless communications device of claim 12, wherein the transmission standard comprises a WiMAX protocol standard.

14. A wireless communications system, comprising:
a base station adapted to communicate by using a modified transmission standard, the transmission standard being modified to support non-standard transmission bandwidths;
a remote transceiver, in wireless communications with the base station, the remote transceiver adapted to communicate by a communications standard and the modified transmission standard, the remote transceiver comprising:
a transmitter configured to transmit according to an OFDM based transmission standard;
a transmission bandwidth controller adapted to configure the transmitter to adjust a transmitted bandwidth of a transmission by one of:
configuring at least one of a first set of punctured subcarriers and a second set of punctured subcarriers to not be used for data transmission, wherein the first set of punctured subcarriers and the second set of punctured subcarriers are located within opposite edges of a transmission bandwidth of the transmission standard, and
configuring at least a first set of guardband subcarriers and a second set of guardband subcarriers to be used for data transmission, wherein the first set of guardband subcarriers and the second set of guardband subcarriers are located within opposite edges of a transmission bandwidth of the transmission standard.

15. The wireless communications device of claim 14, wherein the transmission bandwidth controller adjusts the transmitted bandwidth by configuring the at least one of the first set of punctured subcarriers and the second set of punctured subcarriers to not be used for data transmission, wherein the at least one of the first set of punctured subcarriers and the second set of punctured subcarriers are specified by a wireless transmission system scheduler that transmits a reserved bit in a message transmitted via a broadcast channel, the reserved bit indicating to exclude the first set of punctured subcarriers and the second set of punctured subcarriers from the transmission bandwidth.

16. The wireless communications device of claim 14, wherein the transmission bandwidth controller configures the transmitter in response to receiving an indication transmitted in a in a message transmitted via a broadcast channel transmitted from a base station.

17. The communications device of claim 14, wherein the transmission bandwidth controller adjusts the transmitted bandwidth by configuring the at least one of the first set of punctured subcarriers and the second set of punctured subcarriers to not be used for data transmission.

18. The wireless communications device of claim 14, wherein the transmission bandwidth controller adjusts the transmitted bandwidth by configuring the at least the first set of guardband subcarriers and the second set of guardband subcarriers to be used for data transmission, the wireless communications device further comprising a receiver adapted to receive, in response to a command from a controller, the at least one of the first set of guardband subcarriers and the second set of guardband subcarriers that are received by the receiver.

19. The wireless communications device of claim 14, wherein the transmission standard comprises a WiMAX protocol standard.
